(19) United States
(12) Patent Application Publication
(10) Pub. No.: US 2023/0042579 A1
(43) Pub. Date: Feb. 9, 2023

(54) CHARGER

(71) Applicant: YONGKUI MOU, Yantai (CN)

(72) Inventor: YONGKUI MOU, Yantai (CN)

(21) Appl. No.: 17/672,524

(22) Filed: Feb. 15, 2022

(30) Foreign Application Priority Data
Aug. 3, 2021 (CN) 202121794091.2

(51) Int. Cl. H02J 7/00; H01M 10/052; H01M 10/44

(52) U.S. Cl. CPC H02J 7/0045; H01M 10/44; H01M 10/052; H02J 7/0048

(57) ABSTRACT

A charger, comprising: a charger body, an upper part of one side of which is provided with a placement slot, which is hinged to a charging port and a plug-in rod, the upper part of the body is provided with a power indicator light, the bottom end is provided with a socket for adapting the charging cable, and the other side is provided with a lithium battery placement slot, in which a lithium battery placement case is inserted. Corrugated side support sheets are fixedly connected to both sides in the case, the top end of which is connected to a first conductive sheet, the inner bottom end of which is fixedly connected to a second conductive sheet hinged to the third conductive sheet and a spring is fixedly connected therebetween. The charger has a simple structure, the plug-in rod is hinged. It has a built-in battery as a power bank.

### CROSS-REFERENCE TO RELATED APPLICATIONS

This application claims the benefit and priority of Chinese patent application No. 202121794091.2, filed on Aug. 03, 2021, disclosure of which is hereby incorporated by reference in its entirety.

### TECHNICAL FIELD

The present application relates to the field of electronic equipment, and in particular, to a charger.

### BACKGROUND

The existing chargers are all straight-through type, the charger is plugged into a power socket, and the electronic products are charged through the charging data cable. The plug-in rod of the charger cannot be folded, which is inconvenient to carry, and the charger has no function of storing power, so it can only be charged by plugging into the power supply socket. If you are on a business trip, tourism or meeting in other places, and you cannot find a place with a power supply plug, then there is no way to charge the electronic products in time, and your needs will not be met.

### SUMMARY

In view of the above deficiencies in the prior art, the present application provides a charger, which has a simple structure, the plug-in rod is hinged, it is convenient to fold and store and to carry. It has a built-in lithium battery, which can be used as a power bank when it is necessary to charge electronic products. It has various functions and is convenient for urgent needs.

In order to achieve the above purpose, the technical scheme adopted in this application is:

A charger, comprising: a charger body, an upper part of one side of the charger body is provided with a placement slot, the placement slot is hinged to a charging port and a plug-in rod for charging, the upper part of the charger body is provided with a power indicator light, the bottom end of the charger body is provided with a socket for adapting the charging cable, and the other side of the charger body is provided with a lithium battery placement slot, a lithium battery placement case for placing the lithium battery is inserted in the lithium battery placement slot, corrugated side support sheets are fixedly connected to both sides in the lithium battery placement case, the top end of the lithium battery placement case is fixedly connected to a first conductive sheet, the inner bottom end of the lithium battery placement case is fixedly connected to a second conductive sheet, and the second conductive sheet is hinged to the third conductive sheet. A spring is fixedly connected between the second conductive sheet and the third conductive sheet.

Preferably, anti-skid grooves are arranged at both sides of the middle of the charger body.

Preferably, the upper and lower ends of an opening side of the lithium battery placement slot are provided with snap slots, and the upper and lower ends of the lithium battery placement case away from the center side of the charger body are integrally formed with elastic pieces, which fit into the snap slots.

Preferably, the side of the corrugated side support sheet close to the lithium battery is configured to have an arc structure.

Preferably, the second conductive sheet and the third conductive sheet form a V-shaped structure.

The beneficial effects of this application are:

The plug-in rod is hinged, which is easy to fold and store, easy to carry, and has a built-in lithium battery. When it is necessary to charge electronic products, it can be used as a power bank. It has various functions and is convenient for urgent needs, and the lithium battery is easy to replace.

### BRIEF DESCRIPTION OF DRAWINGS

FIG. 1 is the structural schematic diagram of this application;

FIG. 2 is the bottom view structure schematic diagram of the application;

FIG. 3 is the side structure schematic diagram of the application;

FIG. 4 is a schematic structural diagram of a lithium battery placement case of the application;

FIG. 5 is a schematic diagram of a lithium battery charging circuit of the application.

1-Charger body, 2- Anti-slip groove, 3- Battery indicator light, 4- Plug-in rod, 5- Placement slot, 6- Socket, 7- Lithium battery placement slot, 7.1- Snap slot, 8- Lithium battery placement case, 8.1-Elastic piece, 9-Corrugated side support sheet, 10- First conductive sheet, 11-Spring, 12-Second conductive sheet, 13-Third conductive sheet.

### DETAILED DESCRIPTION

The specific embodiments of the present application will be further described below with reference to the accompanying drawings, wherein the same parts are denoted by the same reference numerals. It should be noted that the words "front", "rear", "left", "right", "upper" and "lower" used in the following description refer to the directions in the drawings, and the words "inner" and "outer" refer to directions towards or away from the geometric center of a particular part, respectively.

In order to make the content of the present application easier to understand clearly, the technical solutions in the embodiments of the present application will be clearly and completely described below with reference to the accompanying drawings in the embodiments of the present application.

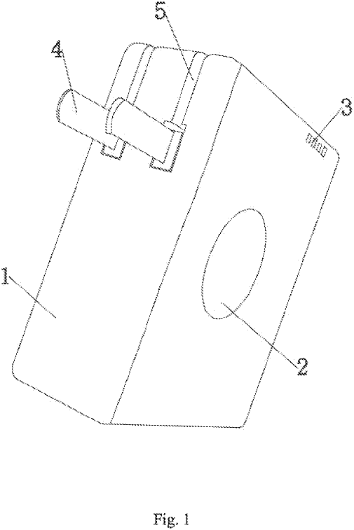

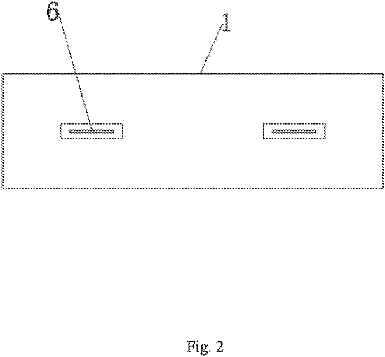

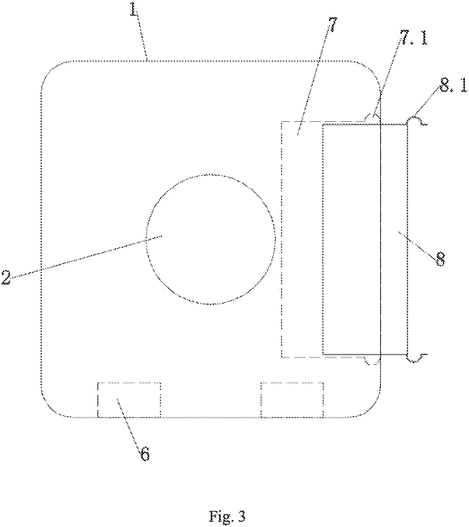

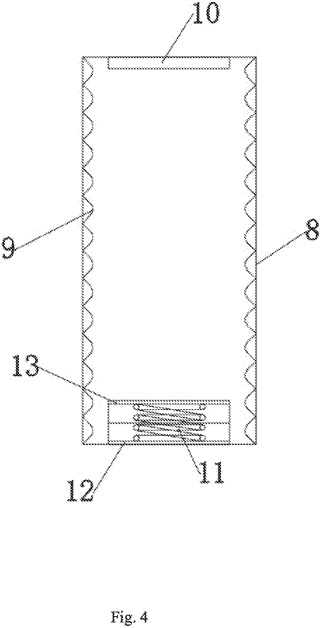

As shown in FIG. 1 to FIG. 4, a charger comprises: a charger body 1, an upper part of one side of the charger body 1 is provided with a placement slot 5, the placement slot 5 is hinged to a charging port and a plug-in rod 4 for charging, the upper part of the charger body 1 is provided with a power indicator light 3, the bottom end of the charger body 1 is provided with a socket 6 for adapting the charging cable, and the other side of the charger body 1 is provided with a lithium battery placement slot 7, a lithium battery placement case 8 for placing the lithium battery is inserted in the lithium battery placement slot 7, corrugated side support sheets 9 are fixedly connected to both sides in the lithium battery placement case 8, the top end of the lithium battery placement case 8 is fixedly connected to a first conductive sheet 10, the inner bottom end of the lithium battery placement case 8 is fixedly connected to a second conductive sheet 12, and the second conductive sheet 12 is hinged to the third conductive sheet 13 and a spring 11 is fixedly connected between the second conductive sheet 12 and the third conductive sheet 13.

Anti-skid grooves 2 are arranged at both sides of the middle of the charger body 1. The upper and lower ends of an opening side of the lithium battery placement slot 7 are provided with snap slots 7.1, and the upper and lower ends of the lithium battery placement case 8 away from the center side of the charger body 1 are integrally formed with elastic pieces 8.1, which fit into the snap slots 7.1. The side of the corrugated side support sheet 9 close to the lithium battery is configured to have an arc structure. The second conductive sheet 12 and the third conductive sheet 13 form a V-shaped structure.

During the use of the device, the plug-in rod is hinged, which is convenient for folding storage and carrying, and the lithium battery is built in the lithium battery placement case 8. When it is necessary to charge electronic products, it can be used as a power bank, which has various functions and is convenient for urgent needs. The upper and lower ends of the opening side of the lithium battery placement slot 7 are provided with snap slots 7.1. The upper and lower ends of the lithium battery placement case 8 away from the center of the charger body 1 are integrally formed with elastic pieces 8.1, which are connected and fit in the slot 7.1. This facilitates the replacement of lithium batteries.

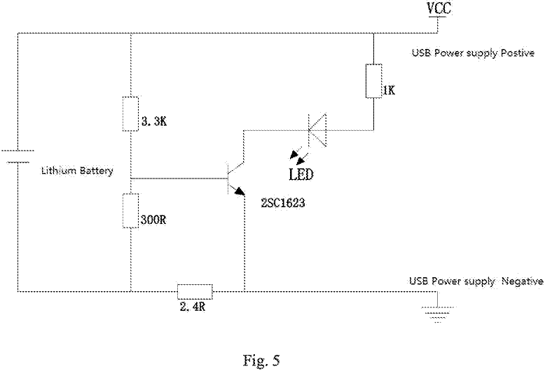

As shown in FIG. 5, when the electronic product is charged by inserting the plug-in rod 4 on the plug tray, the lithium battery is charged and discharged at the same time. When the lithium battery is fully charged, it remains fully charged, which is similar to the charging and discharging mode of the laptop battery in the prior art.

The above are only the preferred embodiments of the present application, and are not intended to limit the present application. Therefore, any modification, equivalent replacement, improvement, etc. made to the above embodiments according to the technical practice of the present application still fall within the scope of the technical solution of the present application.

What is claimed is:

1. A charger, comprising: a charger body (1), an upper part of one side of the charger body (1) is provided with a placement slot (5), the placement slot (5) is hinged to a charging port and a plug-in rod (4) for charging, the upper part of the charger body (1) is provided with a power indicator light (3), the bottom end of the charger body (1) is provided with a socket (6) for adapting the charging cable, and the other side of the charger body (1) is provided with a lithium battery placement slot (7), a lithium battery placement case (8) for placing the lithium battery is inserted in the lithium battery placement slot (7), corrugated side support sheets (9) are fixedly connected to both sides in the lithium battery placement case (8), the top end of the lithium battery placement case (8) is fixedly connected to a first conductive sheet (10), the inner bottom end of the lithium battery placement case (8) is fixedly connected to a second conductive sheet (12), and the second conductive sheet (12) is hinged to the third conductive sheet (13) and a spring (11) is fixedly connected between the second conductive sheet (12) and the third conductive sheet (13).

2. The charger as recited in claim 1, wherein anti-skid grooves (2) are arranged at both sides of the middle of the charger body (1).

3. The charger as recited in claim 1, wherein the upper and lower ends of an opening side of the lithium battery placement slot (7) are provided with snap slots (7.1), and the upper and lower ends of the lithium battery placement case (8) away from the center side of the charger body (1) are integrally formed with elastic pieces (8.1), which fit into the snap slots (7.1).

4. The charger as recited in claim 1, wherein the side of the corrugated side support sheet (9) close to the lithium battery is configured to have an arc structure.

5. The charger as recited in claim 1, wherein the second conductive sheet (12) and the third conductive sheet (13) form a V-shaped structure.
